(19) United States
(12) Patent Application Publication
(10) Pub. No.: US 2004/0243827 A1
(43) Pub. Date: Dec. 2, 2004

(54) Method and system for managing access control

(76) Inventors: Marcos K. Aguilera, Palo Alto, CA (US); Minwen Ji, Sunnyvale, CA (US); Mark David Lillibridge, Mountain View, CA (US); John Philip MacCormick, San Francisco, CA (US); Erwin Oertli, Mountain View, CA (US); David Godbe Andersen, Cambridge, MA (US); Michael Burrows, Palo Alto, CA (US); Timothy P. Mann, Redwood City, CA (US); Chandramohan A. Thekkath, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/449,575

(22) Filed: May 30, 2003

(51) Int. Cl. H04L 9/00

(52) U.S. Cl. 713/200

(57) ABSTRACT

A method for managing access control of a resource includes storing a revocation list containing a list of revoked capabilities and their corresponding groups; storing a group list containing a list of valid groups; receiving a capability revocation request to revoke a specified capability; selecting a revocation method from among a plurality of revocation methods, including an individual capability revocation method and a group revocation method; revoking the specified capability by invalidating the group to which the specified capability belongs if the group revocation method is selected; and revoking the specified capability by invalidating only the specified capability if the individual capability revocation method is selected.

### FIELD OF THE INVENTION

The present invention relates to the field of computer security. In particular, the invention relates to a method and system for managing access control by using capability groups.

### RELATED APPLICATIONS

This application is related to a patent application entitled Method and System for Securing Block-Based Storage with Capability Data, Ser. No. ______, filed on ______, Attorney Docket 9772-0346-999, which is hereby incorporated by reference.

### BACKGROUND OF THE INVENTION

FIG. 1 illustrates a network file system. The network file system includes a group of clients 102, a group of network attached disks (NAD) 108, and one or more metadata servers 106, all connected together via an interconnect 104, such as a Gigabit Ethernet or Fibre Channel network. A Storage Area Network is one example of the network shown in FIG. 1. In FIG. 1, clients 102 access the disk 108 directly without going through the metadata server 106. To access data, a client contacts the metadata server 106 just once to obtain the range of file blocks to be accessed; afterwards, the client accesses the disk by directly issuing read and write requests for blocks of data.

A file has a set of permissions that indicate what types of access one or more clients (or users) have for that file. One way to enforce the access permissions of a file is to use capabilities. When a client 102 wishes to access a file, it requests a capability from the metadata server 102. The metadata server 102 checks if the client 102 is authorized to access the data. If the client 102 is authorized, the metadata server issues a capability to the client 102. The client 102 subsequently includes the capability in its requests to the disk 108. The disk 108 checks if the capability is authentic and matches the request. If so, the request is executed.

A client may wish to modify the permissions of a file so as to disallow certain types of accesses. This operation may require some previously-issued capabilities to be revoked, in order to prevent future accesses with those capabilities. One well-known way to do that is to include expiration times in capabilities, so that they are automatically voided after a while. With such a scheme, there is a delay from the time the permission of a file changes until the new access permissions take full effect. The delay is the maximum time to expire all outstanding capabilities for the file. In many systems, such a delay should be on the order of a few seconds, because clients expect permission changes to be effective quickly (e.g., a client may remove unrestricted read permissions for a file before appending sensitive information). Unfortunately choosing small expiration times poses the problem that capabilities need to be renewed frequently, even when there are no changes in the permissions of a file. This overhead imposed on the metadata server prevents the system from scaling with the number of clients. Rather than relying on expiration, an alternative is to use a mechanism that can revoke capabilities on demand. There are at least two ways to implement such a mechanism.

FIG. 2A illustrates a prior art implementation for managing access control of a network attached disk. As shown in FIG. 2A, the disk 204 keeps an explicit list of all valid capabilities 208, i.e., capabilities that have been issued by the metadata server 202, but have not been revoked. When a client 206 requests to access a file on the disk, it must present a capability that matches one of the capabilities on the list of valid capabilities 208 in order to gain access to the file. When the metadata server 202 issues a new capability, it has to tell the disk 204 to add it to the valid list. When a change to the permissions of a file requires a capability to be revoked, the metadata server tells the disk to remove the capability from the list.

FIG. 2B illustrates another prior art implementation for managing access control of a network attached disk. As shown in FIG. 2B, instead of keeping a list of valid capabilities, the disk 204 keeps a list of revoked capabilities 210. These are capabilities that have been issued but are later revoked. Capabilities that are not on the list are implicitly valid. When a client 206 requests to access a file on the disk, it must present a capability that has a valid signature and is not on the list of revoked capabilities in order to gain access to the file. To issue a new capability, the metadata server 202 simply creates the capability and signs it. There is no need to inform the disk. The disk relies on the signature to ensure that the capability is authentic. When the metadata server 202 wishes to revoke a capability, it tells the disk 204 to add it to the list of revoked capabilities.

However, both access control implementations described above have problems. In FIG. 2A, the list of valid capabilities can grow to an unbounded large size, beyond the available RAM space in the disk. For example, a disk may have millions of files, and each file may have multiple capabilities when it is fragmented and/or accessed by multiple clients. Therefore, the total number of outstanding valid capabilities can be on the order of hundreds of millions. Storing all these capabilities would require a large amount of RAM, which would increase the cost of the storage system.

The implementation in FIG. 2B has a similar RAM space problem because the list of revoked capabilities can grow indefinitely over time. One way to mitigate this problem is to use expiration times for “garbage collection”. Garbage collection is a procedure that periodically removes capabilities that have expired from the list of revoked capabilities. With this garbage collection scheme, there is a tradeoff between RAM space and computation. For example, short expiration times may result in small revocation sets (since they can be garbage collected more frequently), but require a larger overhead on the metadata server to periodically renew capabilities. This method unfortunately does not solve all the problems. In particular, it is possible to have a very large number of revocations within the small period of the garbage collection cycle time, which renders the garbage collection procedure ineffective. For example, a client may change the access control of a top level directory, and cause all of the files underneath that directory to inherit the new access control from the parent directory. Such an operation requires an immediate revocation of a large number of outstanding capabilities. The RAM space available in the disk can be exhausted quickly.

A second drawback of the implementation shown in FIG. 2B is that it is necessary to tune the expiration times. An expiration time that is too large is not helpful to the garbage collection procedure, because a revoked capability can only be garbage collected when it expires. On the other hand, an expiration time that is too small requires a large overhead to periodically renew capabilities that prematurely expire. Choosing the “right” expiration time is a challenging task. Another issue with the implementation shown in FIG. 2B is that the garbage collection procedure requires the disk to have a clock for synchronizing with the clients. The clock must monotonically increase over the life of the disk—including during power failures. To be able to monotonically increase over the life of the disk, the disk needs to either have batteries to preserve the clock or to periodically checkpoint the clock's value to the disk. Either solution adds cost and design complexity to the disk.

One way to solve the RAM problem is to store the list of valid capabilities or the list of revoked capabilities in virtual memory, using the disk as a secondary storage, i.e., the RAM in the disk essentially works as a cache. This scheme would provide a reasonable average-case performance, as long as the cache is large enough to hold the working set of capabilities for all clients. But it is well known that caches cannot be relied upon in systems that need to guarantee a certain quality of service, such as a real-time operating system. In other words, when there are cache misses, a disk request that normally requires only one disk access to complete, would require a few additional accesses in order to retrieve parts of the capability lists that have been swapped out. Under such circumstances, the disk cannot guarantee a read or write operation in less than two disk accesses, for example. Thus, the scheme doubles or more than doubles the worst-case timing guarantees of disk requests. This problem is particularly significant when the disk access time is a dominant factor in the analysis of the system. Furthermore, a virtual memory system unnecessarily complicates the design of the disk.

In view of the shortcomings of the prior art, it is an objective of the present invention to use a relatively small amount of RAM on the disk for storing the access control list and at the same time to support a large number of outstanding capabilities and revocations. Another objective is to eliminate the use of expiration time for revoking capabilities, and hence to eliminate the need for carefully tuning the expiration time and to eliminate the clock on the disk for synchronizing with the clients. It is yet another objective to reduce the cost of the disk by keeping its access control functions simple and moving complex operations to the metadata server.

### SUMMARY

A method of managing access to a resource, such as a disk attached directly to a network, includes storing a revocation list containing a list of revoked capabilities and their corresponding groups and storing a group list containing a list of valid groups of granted capability. Upon receiving a capability revocation request to revoke a specified capability, the method includes selecting a revocation method from among a plurality of revocation methods, including an individual capability revocation method and a group revocation method. If the group revocation method is selected, the specified capability is revoked by invalidating the group to which the specified capability belongs. If the individual capability revocation method is selected, the specified capability by revoked by invalidating only the specified capability (i.e., by adding information about the revoked capability to the list of revoked capabilities).

A metadata server has a capability issuer module configured to store a revocation list containing a list of revoked capabilities and their corresponding groups, to store a group list containing a list of valid groups, to receive a capability revocation request to revoke a specified capability, and to select a revocation method from among a plurality of revocation methods. The revocation methods include an individual capability revocation method and a group revocation method. When the group revocation method is selected, the capability issuer module revokes the specified capability by invalidating the group to which the specified capability belongs, including updating the group list. When the individual capability revocation method is selected, the capability issuer module revokes the specified capability by invalidating only the specified capability, including updating the revocation list.

To control access to the resource, such as a network attached disk, the resource includes a capability checker module having one or more computer programs containing instructions for receiving a request from the client, the request including a capability previously granted to the client; (a) verifying that the request is consistent with the capability; (b) verifying that the capability is valid in accordance with the revocation list and the group list; and if both (a) and (b) are verified, granting the request and executing the request at the resource.

### BRIEF DESCRIPTION OF THE DRAWINGS

The aforementioned features and advantages of the invention as well as additional features and advantages thereof will be more clearly understood hereinafter as a result of a detailed description of embodiments of the invention when taken in conjunction with the following drawings.

FIG. 1 illustrates a network file system where disks are attached directly to the network.

FIG. 2A illustrates a prior art implementation for managing access control of a network attached disk.

FIG. 2B illustrates another prior art implementation for managing access control of a network attached disk.

FIG. 3 illustrates a data structure of the capability data.

FIG. 4 illustrates a mechanism for managing access control by using capability groups.

FIG. 5 illustrates an implementation of tabulating the group list and the revocation list of FIG. 4.

FIG. 6 illustrates a method for managing access control by the capability issuer of the metadata server in FIG. 4.

FIG. 7 illustrates a method for managing access control by the capability checker of the network attached disk in FIG. 4.

### DESCRIPTION OF EMBODIMENTS

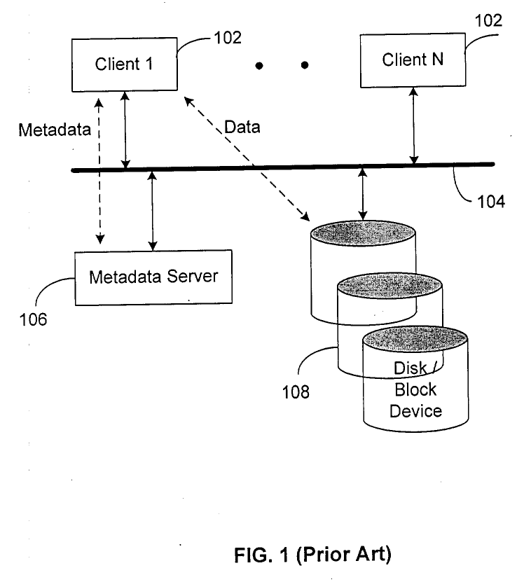

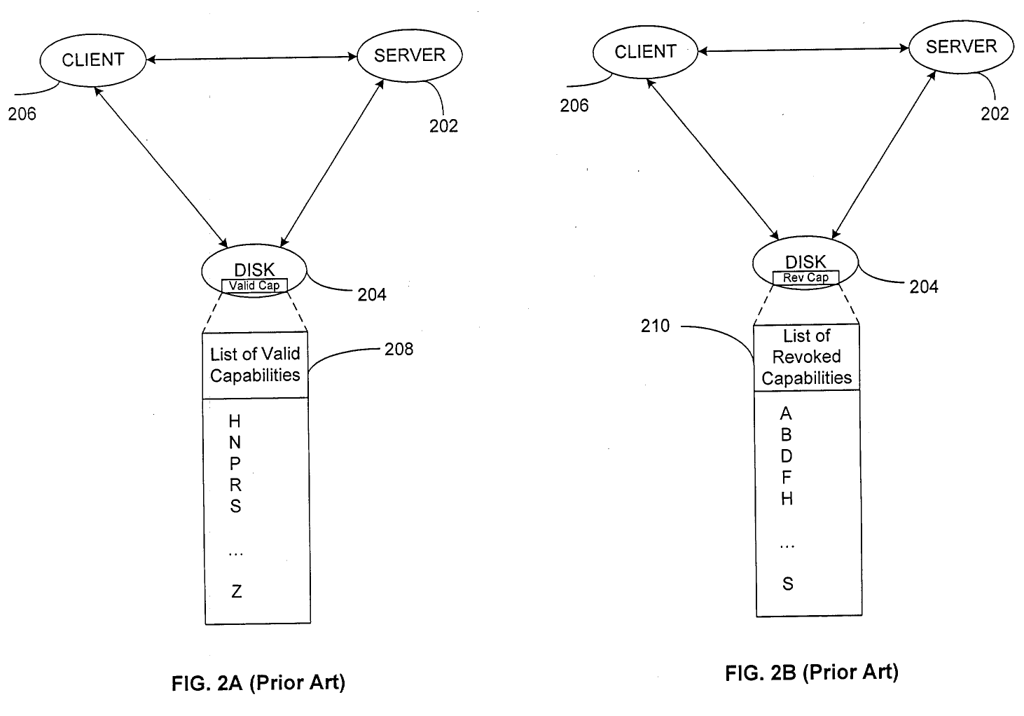

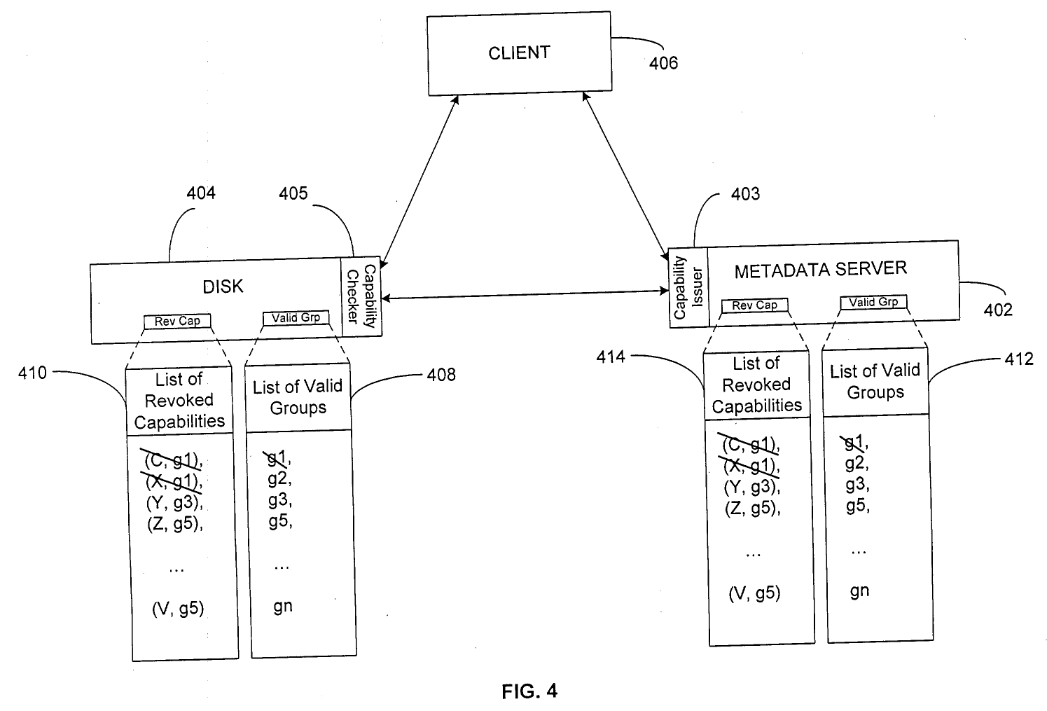

The embodiments described here typically operate in the context of a system such as the one shown in FIG. 1, where disks are attached directly to a network that further contains clients and a metadata server. FIG. 4, which will be described in more detail below, depicts additional structures associated with a metadata server and a disk storage unit that are used in these embodiments.

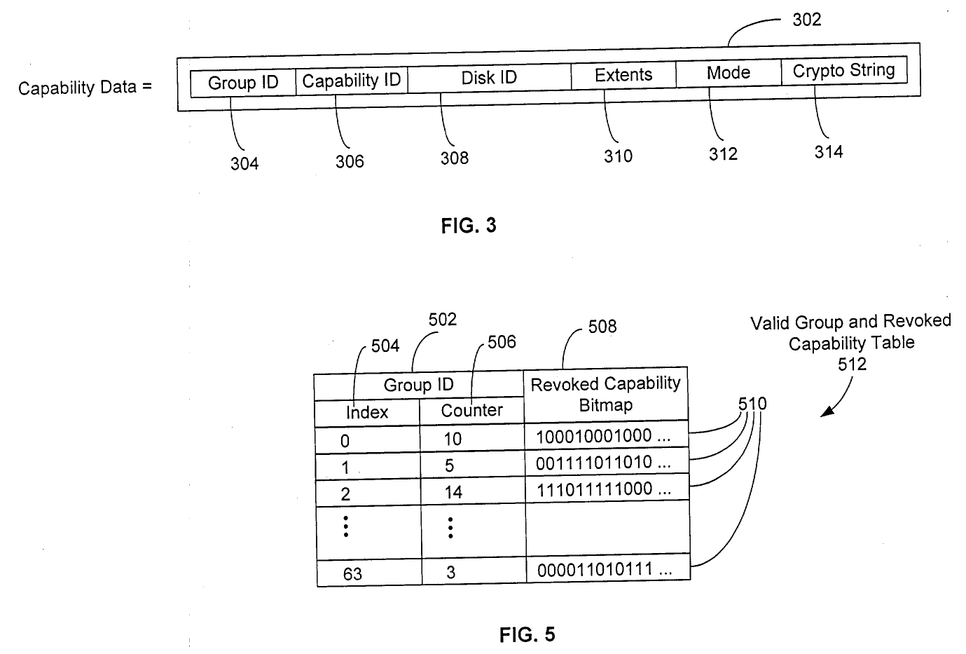

FIG. 3 illustrates a data structure 302 for representing capability data in accordance with an embodiment of the present invention. This data structure 302 is sometimes called a capability certificate. The data structure or certificate 302 represents a capability that has been granted to at least one client in the network. The capability data 302 includes a group identifier 304 for identifying a group the capability belongs to, a capability identifier 306 for identifying (in conjunction with the group identifier) the capability certificate 302, a disk identifier 308 for specifying the disk to which the capability applies, a list of extents 310 for specifying a range of blocks to which access is granted, an access mode 312 for indicating the type of access as read, write or both, and a cryptographic string 314 for preventing forgery of capabilities by unauthorized parties. In an alternate embodiment, the capability identifier 306 may be shared among multiple capabilities in order to save space, but this approach has the tradeoff that capabilities that share the same identifier need to be revoked as a unit.

FIG. 4 illustrates a system for managing access control by using capability groups. The system includes one or more metadata servers 402, one or more network attached disks 404 and one or more clients 406. Each disk 404 includes a capability checker 405, a group list 408 for storing a list of valid groups, and a revocation list 410 for storing a list of revoked capabilities. The metadata server 402 includes a capability issuer 403, and for each disk, the metadata server 402 also includes a group list 412 for storing a list of valid groups and a revocation list 414 for storing a list of revoked capabilities. The revocation list 410 in each disk and the corresponding revocation list 414 in the metadata server contain the same content, except during transitory periods while updates occur. Similarly, the group list 408 in each disk and the corresponding group list 412 in the metadata server contain the same content, except during transitory periods while updates occur. In other words, whenever the capability issuer 403 updates the list of valid groups 412 or the list of revoked capabilities 414 in the metadata server 402, the capability issuer also sends those updates to the corresponding disk to keep the corresponding lists identical.

In general, the capability issuer 403 classifies capabilities into groups, and is configured to selectively invalidate a group when the memory available for storing the revocation list 414 is full, or is approaching a full state, or when the system needs to recycle capability identifiers. For instance, if the list of revoked capabilities has a maximum size of particular number of bytes B, and each entry in the revocation list has a size E, the revocation list 414 is considered to be full when the number of entries in the revocation list equals B/E (rounded down to a whole number, if B/E is not an integer). In another embodiment, described below, the list of revoked capabilities is implemented using a set of bit maps. The list of valid groups is preferably a fixed size list. As explained below, in one embodiment, whenever a group is invalidated, a new group is added, keeping the number of valid groups constant.

There are multiple groups, with the number of groups typically ranging between eight and two hundred fifty six. In one embodiment, sixty-four groups are used. Intuitively, invalidating a group of capabilities avoids the problem of making all capabilities invalid simultaneously, because only a fraction of all the capabilities are affected when invalidating a particular capability group. A capability is deemed valid if the following two conditions are met: (1) its group identifier is in the valid-groups list, and (2) the pair (group identifier, capability identifier) is not in the revocation list. If the revocation list grows too large (i.e., it reaches or approaches the amount of available memory), it is possible to free up entries in the revocation list by selecting a group that appears frequently in the revocation list 410 and making it invalid, and then deleting all the entries in the revocation list 410 corresponding to the invalidated group. For example, by invalidating a group g1 412 from the valid groups list 408, one can free up two entries in the revocation list, namely (C, g1) 414 and (X, g1) 416. Group invalidations, like capability revocations, can only be performed by an authorized party such as the capability issuer.

FIG. 5 illustrates an implementation of the group list and the revocation list of FIG. 4. The group identifier 502 is divided into two parts: a 6 bit index 504 and a 64-bit counter 506. The index of the group identifier 502 is used to index into a 64-entry table 512. Each entry 510 of the table 512 contains the 64-bit counter 506 and a revoked capability bitmap 508, which contains 8,128 bits of revocation data. In one embodiment, the size of each entry 510 is fixed, and therefore the table 512 has a fixed size. In this embodiment, the table 512 can be stored in 64×(8128+64) bits or 64 KB of RAM and supports up to 64×8128=520,192 unique capabilities. In another embodiment, the length of the bitmaps is variable, and therefore size of the entries is variable. The validity of a capability is checked by looking up the entry corresponding to the index part of its group identifier, and verifying that the value of the counter 506 matches the value of the capability's group identifier. Then, if the capability's group identifier matches the corresponding counter, the bit in the bitmap 508 corresponding to the capability identifier is checked. If that bit is set, then the capability has been revoked, and if it is clear, the capability is still valid. To revoke a capability, the bit in the revoked capability bitmap 508 corresponding to the capability identifier is set. On the other hand, a group invalidation is done by clearing the revoked capability bitmap 508 of the group and incrementing its group counter 506, effectively replacing its group identifier with a fresh new one. These operations are simple and time efficient, requiting very little in the way of computational and communication resources. This implementation is also space efficient, as the information for keeping track of each revoked capability occupies on the average about 1 bit of RAM.

It is worth noting that the group list and the revocation list can be stored as a bitmap or as explicit lists. The bitmap representation has the advantage that it is compact, but it requires capability identifiers to be small and thus limits the number of outstanding capabilities. With the explicit list representation, the capability identifier can be large enough to ensure a large number of outstanding capabilities. For example, a 128-bit capability identifier supports more than 10³⁸ capabilities.

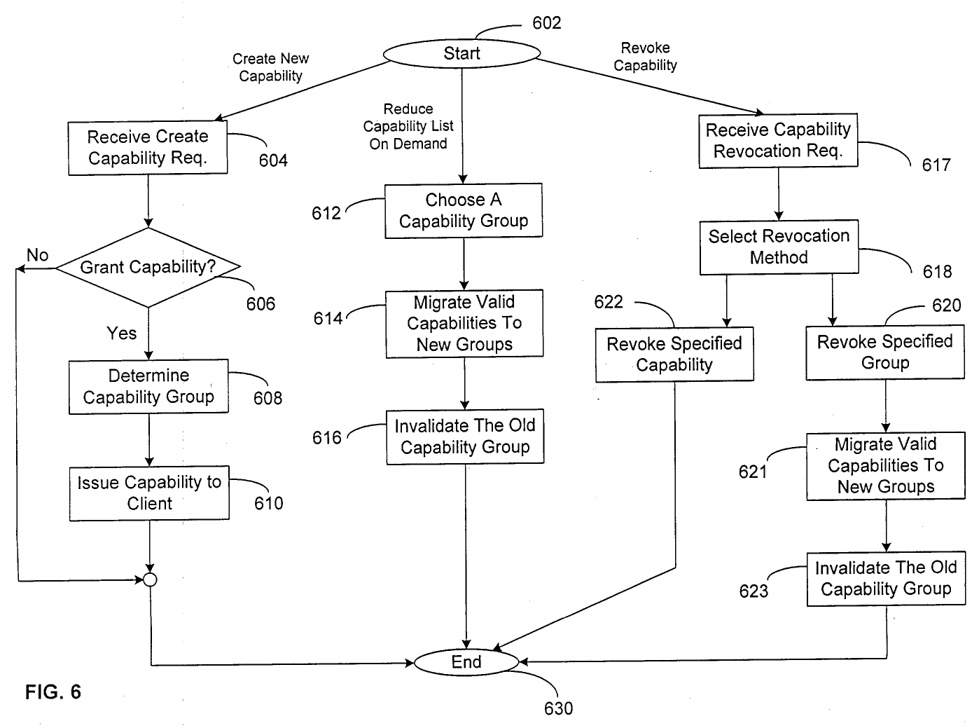

FIG. 6 illustrates a method for managing access control by the capability issuer of the metadata server in FIG. 4. The capability issuer 403 performs three main tasks. First, it serves a request for creating a capability. The method starts in step 602 and thereafter moves to step 604 where it receives a request to create new capability for accessing the disk 404. In step 606, the capability issuer 403 determines the client's access permission by applying a set of predetermined policies. If the client's capability request is not accepted, then the capability issuer issues a rejection to the client and the method ends in step 630. In the alternative, if the client's capability request is accepted, the method continues at step 608. In step 608, the capability issuer determines the capability group into which the new capability should be placed. In one embodiment, the capability issuer bases its selection of a capability group on (1) the likelihood that the capability will be revoked and (2) the number of clients that are likely to be given the same capability. For example, capabilities judged to be likely to be revoked quickly may be placed in a first group or within a first set of groups; capabilities judged to be likely to be shared by multiple clients may be placed in a second group within a second set of groups; and so on. Next, in step 610, the capability issuer generates the capability (for example, using the data structure shown in FIG. 3) and issues the capability to the client 406. Generating and issuing the capability includes, in one embodiment, digitally signing or otherwise adding an cryptographically generated string 314 to the capability so that the capability checker 405 can verify that a proffered capability was issued by the capability issuer. The method ends in step 630.

A second task performed by the capability issuer is to reduce the size of the group list 412 and the revocation list 414 on demand. The method starts in step 602 and thereafter moves to step 612 where the capability issuer chooses a group to invalidate. Before invalidating a group, the capability issuer has to first address the adverse side effects of revoking capabilities in the group that should not have been revoked. For example, if the group g1 is to be invalidated, but that group contains a capability (A,g1) that has not been revoked, then (A,g1) will no longer be valid, even though it is not desired to be revoked. This problem can be resolved by having the client who holds (A,g1) request a new capability, and then having the capability issuer issues a new capability. However, there is a cost associated with this procedure because when the client attempts to use the capability (A,g1) in order to perform an associated disk access operation, it will receive a message stating that this capability is no longer valid. To continue with the disk access operation, it must request a new capability and wait for the capability issuer to issue the new capability. This procedure involves two extra network round trips (i.e., three transactions instead of one). One approach to avoid this extra cost is to minimize the number of valid capabilities to be revoked.

There are several mechanisms for minimizing the number of valid capabilities that are revoked. One mechanism is to carefully pick a group with few outstanding valid capabilities to invalidate. However, this choice may not free up many entries in the revocation list, as the group itself may have a small number of capabilities. In fact, if every capability has the same likelihood of being invalidated, then it is likely that each group has more or less the same ratio of valid and revoked capabilities. In that case, the benefit of invalidating a group (measured by the number of entries that can be freed in the revocation list) is directly proportional to its cost (measured by the number of parties that will need to get new capabilities because valid capabilities are invalidated). In other words, the cost-benefit ratio is constant and independent of which group is invalidated.

However, in many cases, different capabilities can have different likelihoods of being revoked. For example, if capabilities are used to control access to files in a file system, a read-only capability for a shared library is unlikely to be revoked, whereas a read-write capability for a newly created private file is much more likely to be revoked. Another scenario is that a capability which is likely to be revoked is unlikely to be distributed among many clients. In those cases, the cost-benefit ratio can be improved by designating certain groups as highly volatile and others groups as stable. Capabilities that are likely to be revoked and unlikely to be spread widely are assigned to a highly volatile group, whereas capabilities that are unlikely to be revoked and are likely to be widespread are assigned to a stable group. In an alternate embodiment, there can be groups of intermediate volatility between the highly volatile group and the stable group. As a result, the cost-benefit ratio of invalidating highly volatile groups is significantly greater than the cost-benefit ratio for stable groups.

When there is need to free up entries in the revocation list, the capability issuer can choose a highly volatile group to invalidate. For example, the capability issuer may be configured to assign volatile capabilities (likely to be revoked) to a set of V groups in accordance with a predefined group assignment methodology, and to invalidate these V groups (herein called “volatile groups”) in round robin order as groups need to be invalidated. To improve the odds that most of the capabilities in an invalidated group have been revoked, the capability issuer may assign volatile capabilities to each group in the set of V groups until it is full before moving onto the next group in the set of V groups. As a result, when a volatile group is invalidated, its capabilities will be the oldest volatile capabilities that have not yet been invalidated.

After choosing a capability group to invalidate, in step 614, the capability issuer may optionally migrate valid capabilities within the group to new groups. To do so, the capability issuer keeps a list of clients to whom each capability has been previously issued. This information may be kept in a log or in an appropriately organized database. This list is used to inform clients that the corresponding capabilities previously issued have been migrated to a new group. Note that this list can grow to a very large size, but since the capability issuer resides in the metadata server, it has more memory to store the list than the capability checker in the network attached disk. In fact, the list can be stored on disk instead of main memory. Migrating a valid capability includes two steps: (1) creating capabilities in a new group that are equivalent to previously issued ones, and (2) transmitting these new capabilities to the clients that have the old capabilities. Upon receiving the new capabilities, the clients replace the old capabilities with the new ones. Once all valid capabilities in a group have been migrated, in step 616, the capability issuer can safely invalidate the group without any adverse side effects. The method ends in step 630. It is noted that if step 614 is not performed, and thus the valid capabilities in the selected group are not migrated, clients will need to request issuance of replacement capabilities when their access requests using the old, invalid capabilities are rejected.

A third task performed by the capability issuer is to serve a request to revoke a previously issued capability. The method starts in step 602 and thereafter moves to step 617 where the capability issuer receives a capability revocation request to revoke a specific capability. In step 618, the capability issuer selects from a set of revocation methods for revoking the specific capability. The methods include revoking the specific capability individually, or revoking the group that the specific capability belongs to. The capability issuer makes its decision according to a predefined set of factors. The factors used by the capability issuer in one embodiment include 1) whether the list of revoked capabilities is full, or alternately has reached a predefined level of fullness; 2) which group the specific capability belongs to; 3) the volatility of the group; and 4) the number of non-revoked capabilities in the group. In other embodiments, fewer factors or different factors may be used. If the selected method is to revoke a specific capability, the method moves to step 622 where the capability issuer adds the specific capability to the corresponding revocation list 414 and then informs the capability checker to update its revocation list 410.

In the alternative, if the selected method is to invalidate the group to which the capability belongs, the method moves to step 620. In step 621, the method may optionally migrate valid capabilities within the group to new groups, as described above with reference to step 614. Once all valid capabilities in a group have been migrated, in step 623, the capability issuer invalidates the selected group. In addition, the capability issuer informs the capability checker(s) to update (synchronize) its group list and the revocation list. The method ends in step 630.

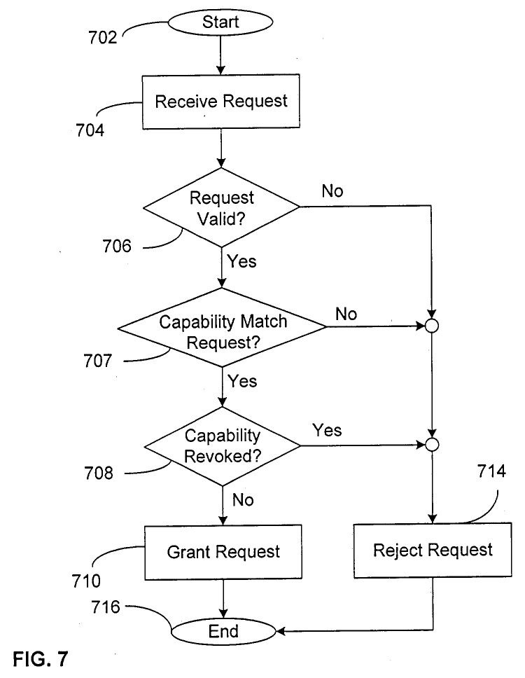

FIG. 7 illustrates a method of managing access control by the capability checker 405 of the network attached disk in FIG. 4. The capability checker is responsible for checking the validity and authenticity of capabilities. The method starts in step 702 and thereafter it moves to step 704 where the capability checker receives a request from the client 406. In step 706, a first determination is made as to whether the access request is valid by checking whether the capability submitted by the client has been forged. In one embodiment, the authenticity of the submitted capability is determined using a message authentication code or a digital signature scheme, utilizing the cryptographic string 314 (FIG. 3) of the capability data structure in conjunction with the other portions of the capability data structure. In other embodiments, other methodologies are used to authenticate the request. If the request is not authentic (706-No), the NO path is taken and the method moves to step 714 where the capability checker rejects the request. In the alternative, if the request is authentic (706-Yes), the YES path is taken and the method continues at step 707. In step 707, a second determination is made as to whether the capability matches the request. If the capability does not match the request (707-No), the NO path is taken and the method moves to step 714, where the capability checker rejects the request. In the alternative, if the capability matches the request (707-Yes), the YES path is taken and the method continues at step 708. In step 708, a third determination is made as to whether the capability has been revoked. This determination is made using the valid group list and the revoked capability list. A capability is valid (i.e., not revoked) when the group identifier of the capability is on the valid group list and the pair containing the capability identifier and the group identifier is not on the list of revoked capabilities. If the capability is not valid (i.e., revoked), the method goes to step 714 where the capability checker rejects the request. In the alternative, if the capability is valid, the method continues at step 710, where the capability checker accepts the client's request. The method ends in step 716. In other embodiments steps 706, 707 and 708 may be performed in a different order from the order described above.

The disclosed method for managing access control provides at least three advantages for systems where disks are attached directly to the network. First it uses a relatively small amount of RAM in the disk for storing the revocation list and the group list and at the same time supports a large number of outstanding capabilities and revocations. Second, it does not use expiration times for revoking capabilities and hence there is no need for carefully tuning the expiration times and there is no need for a clock in the disk to be synchronized with clocks used by the client computers. Third, it keeps the cost of the disk low by keeping it a simple low-level block access device for performing its main function of reading and writing blocks, and by moving the complex capability maintenance operations to the metadata server.

One skilled in the relevant art will easily recognize that there are many possible modifications of the disclosed embodiments that could be used, while still employing the same basic underlying mechanisms and methodologies. For example, the bit map containing the revoked capability list and valid group list can have an adjustable dimension that fits a particular design need. In addition, one can use more bits to describe the group identifier and less bits to describe the capabilities, or vice versa.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for managing revocation of capabilities, each capability authorizing access to a resource of a system, comprising:
storing a group list containing a list of valid groups of capabilities, each capability authorizing access to a resource of the system having a corresponding group;
storing a revocation list containing a list of revoked capabilities and their corresponding groups;
receiving a capability revocation request to revoke a specified capability;
selecting a revocation method from among a plurality of revocation methods, including an individual capability revocation method and a group revocation method;
when the group revocation method is selected, revoking the specified capability by invalidating the group to which the specified capability belongs, including updating the group list; and
when the individual capability revocation method is selected, revoking the specified capability by invalidating only the specified capability, including updating the revocation list.

2. The method of claim 1, including:
determining whether to accept or reject the capability revocation request in accordance with a predetermined set of rules; and
if the capability revocation request is accepted, revoking the capability.

3. The method claim 1, wherein the revocation list comprises a server revocation list on a metadata server and a resource revocation list on the resource, both the server revocation list and the resource revocation list having the same content.

4. The method of claim 1, wherein the group list comprises a server group list on a metadata server and a resource group list on the resource, both the server group list and the resource group list having the same content.

5. The method of claim 1, wherein storing a group list comprises:
designating one or more volatile groups of capabilities, to include capabilities deemed likely to be revoked and unlikely to be spread widely among clients in the system; and
designating one or more stable groups to include capabilities deemed unlikely to be revoked and likely to be spread widely among clients in the system.

6. The method of claim 1, wherein the capability comprises a capability identifier and a group identifier.

7. The method of claim 6, wherein the revocation list includes a bit vector for each group, the bit vector identifying revoked capabilities associated with the group;
revoking the specified capability further comprises changing a corresponding bit in the bit vector for the group associated with the specified capability.

8. The method of claim 1, wherein
the capability comprises a capability identifier and a group identifier, wherein the capability identifier is represented by a first number and the group identifier is represented by a group index and a second number corresponding to the group index;
the group list comprises a list of group identifiers, each group identifier in the group list indicating a valid group, each group identifier including a group index and a second number; and
invalidating the group includes changing, in the group list, the second number of the group identifier corresponding to the group.

9. The method of claim 1 further comprising:
at a resource, receiving a request from the client, the request including a capability previously granted to the client;
at the resource,
(a) verifying that the request is consistent with the capability; and
(b) verifying that the capability is valid in accordance with the revocation list and the group list; and
if either (a) or (b) fails, rejecting the request.

10. The method of claim 9, wherein the capability is valid if the capability is not in the revocation list and the group of the capability is in the group list.

11. The method of claim 1 further comprising:
at a metadata server, receiving a request to change permissions of a resource from the client,
at the metadata server, determining whether to accept or reject the request to change permissions in accordance with a predetermined set of rules;
if the request to change permissions is accepted, revoking capabilities in accordance with the request to change permissions.

12. The method of claim 11 further comprising:
if the request to change permissions is accepted, generating a new capability in response to the newly accepted permissions; and
issuing the new capability to the client.

13. The method of claim 12, wherein generating a new capability comprises:
determining a group for the new capability, the determining being performed at least in part in accordance with a deemed likelihood of the new capability being revoked; and
including an identifier for the determined group in the new capability.

14. The method of claim 13, wherein determining is further performed at least in part in accordance with a deemed likelihood of the new capability being spread widely among clients in the system.

15. The method of claim 1, including generating a new capability, said generating a new capability including:
determining a group for the new capability, the determining being performed at least in part in accordance with a deemed likelihood of the new capability being revoked; and
including an identifier for the determined group in the new capability.

16. The method of claim 15, wherein determining is further performed at least in part in accordance with a deemed likelihood of the new capability being spread widely among clients in the system.

17. The method of claim 1 further comprising:
on demand, selecting a capability group with a plurality of entries in the revocation list;
migrating previously issued valid capabilities in the selected capability group to one or more other groups; and
invalidating the selected capability group such that the selected capability group is no longer included in the group list.

18. The method of claim 17, wherein migrating the valid capabilities comprises:
creating, in the one or more other groups, new capabilities that are equivalent to the valid capabilities; and
sending each new capability to a party who has the corresponding previously issued valid capability.

19. The method of claim 1 including:
determining whether the revocation list satisfies a predefined fullness condition, and when the revocation list satisfies the predefined fullness condition:
selecting a group to invalidate;
migrating previously issued valid capabilities in the selected group to one or more other groups; and
invalidating the selected group such that the selected group is no longer included in the group list.

20. The method of claim 19, wherein migrating the valid capabilities comprises:
creating, in the one or more other groups, new capabilities that are equivalent to the valid capabilities; and
sending each new capability to a party who has the corresponding previously issued valid capability.

21. A system for managing revocation of capabilities, each capability authorizing access to a resource of a system, comprising:
at least a metadata server having one or more processing units for executing computer programs, and having one or more network interfaces for exchanging information with devices coupled to a network;
at least a resource having one or more processing units for executing computer programs, and having one or more network interfaces for exchanging information with the resources;
the metadata server including a capability issuer module, the capability issuer module including one or more computer programs containing instructions for:
storing a group list containing a list of valid groups of capabilities, each capability authorizing access to a resource of the system having a corresponding group;
storing a revocation list containing a list of revoked capabilities and their corresponding groups;
receiving a capability revocation request to revoke a specified capability;
selecting a revocation method from among a plurality of revocation methods, including an individual capability revocation method and a group revocation method;
when the group revocation method is selected, revoking the specified capability by invalidating the group to which the specified capability belongs, including updating the group list; and
when the individual capability revocation method is selected, revoking the specified capability by invalidating only the specified capability, including updating the revocation list;
the resource including a capability checker module, the capability checker module including one or more computer programs containing instructions for:
receiving a request from the client, the request including a capability previously granted to the client;
(a) verifying that the request is consistent with the capability; and
(b) verifying that the capability is valid in accordance with the revocation list and the group list; and
if either (a) or (b) fails, rejecting the request.

22. The system of claim 21, wherein the capability issuer module including one or more computer programs containing instructions for:
determining whether to accept or reject the capability revocation request in accordance with a predetermined set of rules; and
if the capability revocation request is accepted, revoking the capability.

23. The system of claim 21, wherein the revocation list comprises a server revocation list on a metadata server and a resource revocation list on the resource, both the server revocation list and the resource revocation list having the same content.

24. The system of claim 21, wherein the group list comprises a server group list on a metadata server and a resource group list on the resource, both the server group list and the resource group list having the same content.

25. The system of claim 21, wherein the instructions for storing a group list comprises:
designating one or more volatile groups of capabilities, to include capabilities deemed likely to be revoked and unlikely to be spread widely among clients in the system; and
designating one or more stable groups to include capabilities deemed unlikely to be revoked and likely to be spread widely among clients in the system.

26. The system of claim 21, wherein the capability comprises a capability identifier and a group identifier.

27. The system of claim 26, wherein the revocation list includes a bit vector for each group, the bit vector identifying revoked capabilities associated with the group;
revoking the specified capability further comprises changing a corresponding bit in the bit vector for the group associated with the specified capability.

28. The system of claim 21, wherein
the capability comprises a capability identifier and a group identifier, wherein the capability identifier is represented by a first number and the group identifier is represented by a group index and a second number corresponding to the group index; and
the group list comprises a list of group identifiers, each group identifier in the group list indicating a valid group, each group identifier including a group index and a second number; and
the instructions for invalidating the group include instructions for changing, in the group list, the second number of the group identifier corresponding to the group.

29. The system of claim 28, wherein the capability is valid if the capability is not in the revocation list and the group of the capability is in the group list.

30. The system of claim 21, wherein the capability issuer module including one or more computer programs further containing instructions for:
receiving a request to change the permissions of a resource from the client,
determining whether to accept or reject the request to change permissions in accordance with a predetermined set of rules;
if the request to change permissions is accepted, revoking capabilities in accordance with the request to change permissions.

31. The system of claim 30 further comprising:
if the request to change permissions is accepted, generating a new capability in response to the newly accepted permissions; and
issuing the new capability to the client.

32. The system of claim 31, wherein instructions for generating a new capability comprises:
determining a group for the new capability, the determining being performed at least in part in accordance with a deemed likelihood of the new capability being revoked; and
including an identifier for the determined group in the new capability.

33. The system of claim 32, wherein instructions for determining is further performed at least in part in accordance with a deemed likelihood of the new capability being spread widely among clients in the system.

34. The system of claim 21, including instructions for generating a new capability, said instructions for generating a new capability including:
determining a group for the new capability, the determining being performed at least in part in accordance with a deemed likelihood of the new capability being revoked; and
including an identifier for the determined group in the new capability.

35. The system of claim 34, wherein instructions for determining is further performed at least in part in accordance with a deemed likelihood of the new capability being spread widely among clients in the system.

36. The system of claim 21, wherein the capability issuer module including one or more computer programs further containing instructions for:
on demand, selecting a capability group with a plurality of entries in the revocation list;
migrating previously issued valid capabilities in the selected capability group to one or more other groups; and
invalidating the selected capability group from the group list.

37. The system of claim 36, wherein instructions for migrating the valid capabilities comprises the steps of:
creating, in the one or more other groups, new capabilities that are equivalent to the valid capabilities; and
sending each new capability to a party who has the corresponding previously issued valid capability.

38. The system of claim 21, wherein the capability issuer module including one or more computer programs further including instructions for:
determining whether the revocation list satisfies a predefined fullness condition, and when the revocation list satisfies the predefined fullness condition:
selecting a group to invalidate;
migrating previously issued valid capabilities in the selected group to one or more other groups; and
invalidating the selected group such that the selected group is no longer included in the group list.

39. The system of claim 38, wherein instructions for migrating the valid capabilities comprises the steps of:
creating, in the one or more other groups, new capabilities that are equivalent to the valid capabilities; and
sending each new capability to a party who has the corresponding previously issued valid capability.

40. A computer program product, comprising a medium storing computer programs for execution by one or more computer systems, the computer program comprising:
a capability issuer module, for use in conjunction with a metadata server, the capability issuer module including one or more computer programs containing instructions for:
generating a revocation list for storing a list of revoked capabilities;
generating a group list for storing a list of valid groups of capabilities, each capability authorizing access to a resource of the system having a corresponding group;
receiving a capability revocation request from a client;
determining whether to accept or reject the capability revocation request in accordance with a predetermined set of rules; and
if the capability revocation request is accepted, revoking the capability previously granted to the client by invalidating the group to which the capability belongs to;
updating the revocation list; and
updating the group list;
a capability checker module for use in conjunction with a resource, the capability checker module including one or more computer programs containing instructions for:
receiving a request from the client, the request including a capability previously granted to the client;
(a) verifying that the request is consistent with the capability; and
(b) verifying that the capability is valid in accordance with the revocation list and the group list; and
if either (a) or (b) fails, rejecting the request.

41. The computer product of claim 40, wherein the capability issuer module including one or more computer programs containing instructions for:
determining whether to accept or reject the capability revocation request in accordance with a predetermined set of rules; and
if the capability revocation request is accepted, revoking the capability.

42. The computer product of claim 40, wherein the revocation list comprises a server revocation list on a metadata server and a resource revocation list on the resource, both the server revocation list and the resource revocation list having the same content.

43. The computer product of claim 40, wherein the group list comprises a server group list on a metadata server and a resource group list on the resource, both the server group list and the resource group list having the same content.

44. The computer product of claim 40, wherein the instructions for storing a group list comprises:
designating one or more volatile groups of capabilities, to include capabilities deemed likely to be revoked and unlikely to be spread widely among clients in the system; and
designating one or more stable groups to include capabilities deemed unlikely to be revoked and likely to be spread widely among clients in the system.

45. The computer product of claim 40, wherein the capability comprises a capability identifier and a group identifier.

46. The computer product of claim 45, wherein the revocation list includes a bit vector for each group, the bit vector identifying revoked capabilities associated with the group;
revoking the specified capability further comprises changing a corresponding bit in the bit vector for the group associated with the specified capability.

47. The computer product of claim 40, wherein
the capability comprises a capability identifier and a group identifier, wherein the capability identifier is represented by a first number and the group identifier is represented by a group index and a second number corresponding to the group index; and
the group list comprises a list of group identifiers, each group identifier in the group list indicating a valid group, each group identifier including a group index and a second number; and
the instructions for invalidating the group include instructions for changing, in the group list, the second number of the group identifier corresponding to the group.

48. The computer product of claim 47, wherein the capability is valid if the capability is not in the revocation list and the group of the capability is in the group list.

49. The computer product of claim 40, wherein the capability issuer module including one or more computer programs further containing instructions for:
receiving a request to change the permissions of a resource from the client, determining whether to accept or reject the request to change permissions in accordance with a predetermined set of rules;
if the request to change permissions is accepted, revoking capabilities in accordance with the request to change permissions.

50. The computer product of claim 49 further comprising:
if the request to change permissions is accepted, generating a new capability in response to the newly accepted permissions; and
issuing the new capability to the client.

51. The computer product of claim 50, wherein instructions for generating a new capability comprises:
determining a group for the new capability, the determining being performed at least in part in accordance with a deemed likelihood of the new capability being revoked; and
including an identifier for the determined group in the new capability.

52. The computer product of claim 51, wherein instructions for determining is further performed at least in part in accordance with a deemed likelihood of the new capability being spread widely among clients in the system.

53. The computer product of claim 40, including instructions for generating a new capability, said instructions for generating a new capability including:
determining a group for the new capability, the determining being performed at least in part in accordance with a deemed likelihood of the new capability being revoked; and
including an identifier for the determined group in the new capability.

54. The computer product of claim 53, wherein instructions for determining is further performed at least in part in accordance with a deemed likelihood of the new capability being spread widely among clients in the system.

55. The computer product of claim 40, wherein the capability issuer module including one or more computer programs further containing instructions for:
on demand, selecting a capability group with a plurality of entries in the revocation list;
migrating previously issued valid capabilities in the selected capability group to one or more other groups; and
invalidating the selected capability group such that the selected capability group is no longer included in the group list.

56. The computer product of claim 55, wherein instructions for migrating the valid capabilities comprises the steps of:
creating, in the one or more other groups, new capabilities that are equivalent to the valid capabilities; and
sending each new capability to a party who has the corresponding previously issued valid capability.

57. The computer product of claim 40, wherein the capability issuer module including one or more computer programs further including instructions for:
determining whether the revocation list satisfies a predefined fullness condition, and when the revocation list satisfies the predefined fullness condition:
selecting a group to invalidate;
migrating previously issued valid capabilities in the selected group to one or more other groups; and
invalidating the selected group such that the selected group is no longer included in the group list.

58. The computer product of claim 57, wherein instructions for migrating the valid capabilities comprises the steps of:
creating, in the one or more other groups, new capabilities that are equivalent to the valid capabilities; and
sending each new capability to a party who has the corresponding previously issued valid capability.
